(19) United States
(12) Patent Application Publication
(10) Pub. No.: US 2011/0072370 A1
(43) Pub. Date: Mar. 24, 2011

(54) USER INTERFACE MODIFIER

(76) Inventors: April S. Mitchell, San Jose, CA (US); Ian N. Robinson, Pebble Beach, CA (US)

(21) Appl. No.: 12/992,101

(22) PCT Filed: May 20, 2008
(86) PCT No.: PCT/US08/64234

§ 371 Date: Nov. 11, 2010

(51) Int. Cl. G06F 3/01

(52) U.S. Cl. 715/762

(57) ABSTRACT

Various embodiments of the present technology, a method [300] of modifying a user interface of a device, are described. In one embodiment, a user interaction attribute profile for a device is accessed [305]. The user interface of the device is then modified based on the user interaction attribute profile [310].

### FIELD

The field of the present technology relates to computing systems. More particularly, embodiments of the present technology relate to user interfaces.

### BACKGROUND

The average person owns at least one computing device, such as a desktop computer, a laptop computer, a mobile phone, and/or a personal data assistant. Each of these computing devices comes generically pre-configured by the company from which it was purchased. For example, a company may pre-configure the look and feel of a computing device's user interface.

The pre-configured user interface may show a host of images in the form of icons and text. As many icons as there are applications may be displayed on the user interface. In addition to applications, particular machines, devices, computer programs, or other complex tools may be represented by images or text upon a user interface.

However, computing devices' current operating systems provide users with limited options for modifying a user interface. A user has little control over the main user interface, even though the user may change a background picture, add and remove icons, and change icon names and fonts. Additionally, any changes to a computing device's desktop setting must be made manually by the user, thus wasting time and resources.

### SUMMARY

Various embodiments of the present technology, a method of modifying a user interface of a device, are described. In one embodiment, a user interaction attribute profile for a device is accessed. The user interface of the device is then modified based on the user interaction attribute profile.

### BRIEF DESCRIPTION OF THE DRAWINGS

FIG. 1 is a block diagram of an example environment comprising multiple users and multiple devices in accordance with embodiments of the present technology.

FIG. 2 is a block diagram of an example user interface modifier in accordance with embodiments of the present technology.

FIG. 3 is a flowchart of an example method of modifying a user interface of a device in accordance with embodiments of the present technology.

FIG. 4 is a diagram of an example computer system used for providing a method of modifying a user interface of a device in accordance with embodiments of the present technology.

FIG. 5 is a flowchart of an example method of modifying a user interface of a device in accordance with embodiments of the present technology.

The drawings referred to in this description should be understood as not being drawn to scale except if specifically noted.

### DETAILED DESCRIPTION

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “accessing”, “modifying”, “utilizing”, “providing”, “sharing”, “sorting”, “indexing”, “sending”, “generating”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical and mechanical computers.

Embodiments of the present technology track a user's interaction with a device, and then create a customized user interface for the device based upon the tracked user interactions. For example, a customized user interface may include a unique visual layout of the user's data and applications on a first device's main screen, which reflects a user's contemplated interaction with the device. These tracked user interactions with a first device may be shared with a second device, in order to create a familiar layout on a second device's main screen that is similar to the first device's visual layout. By enabling the sharing of tracked user interactions, a user avoids having to manually initialize various computing devices with a preferred interface, thus saving time and resources.

The discussion will begin with an overview of an environment comprising multiple users of multiple devices, and the role user interface modifier (UIM) plays within this environment in modifying a user interface of a device according to embodiments of the present technology. The discussion will then focus on embodiments and methods of the present technology that modify a user interface of a device.

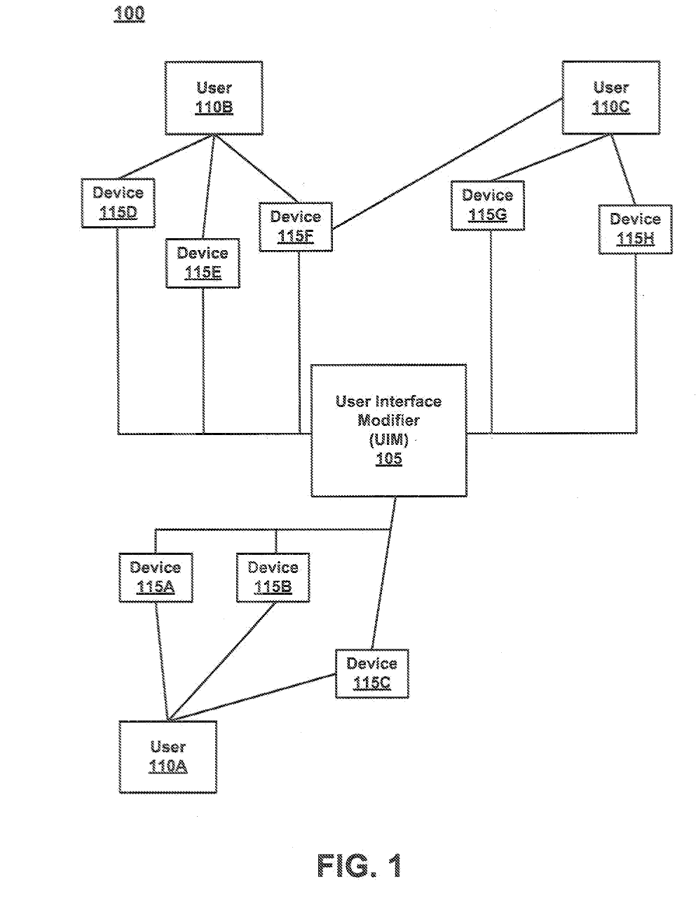

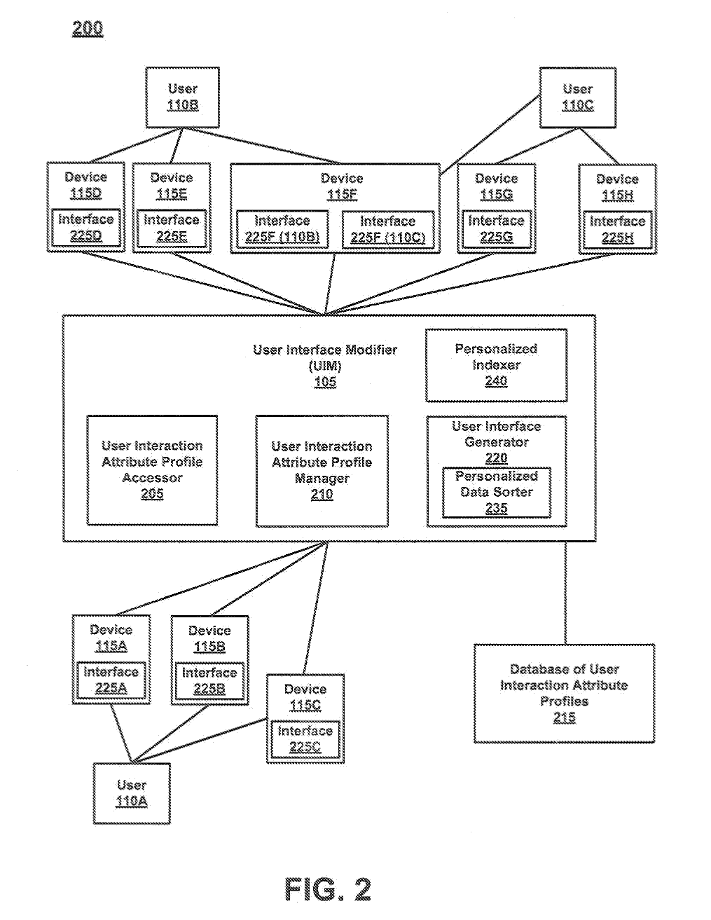

With reference now to FIG. 1, a block diagram of an example environment 100 comprising multiple users and multiple devices is shown in accordance with embodiments of the present technology. Environment 100 includes multiple users, user 110A, user 110B, and user 110C. Additionally, coupled with user 110A are devices 115A, 115B, and 115C. Coupled with devices 115A, 115B, and 115C (as shown in FIG. 2) are interfaces 225A, 225B, and 225C respectively.

Coupled with user 110B are devices 115D, 115E, and 115F. Coupled with devices 115D and 115E (as shown in FIG. 2) are interfaces 225D and 225E respectively. Coupled with device 115F (as shown in FIG. 2) are interfaces 225F(110B) and 225F(110C). As shown, device 115F is coupled with two separate users, users 110B and 110C, and two separate interfaces 225F(110B) and 225F(110C) are generated relating to user 110B and 110C respectively.

Coupled with user 110C are devices 115F, 115G, and 115H. Coupled with devices 115G and 115H (as shown in FIG. 2) are interfaces 225G and 225H. It should be appreciated that any number of users and any number of devices may be included in environment 100 in accordance with embodiments of the present technology. Users 110A, 110B, and 110C are coupled with user interface modifier (UIM) 105.

Additionally, it should be noted that device 115F is coupled with both user 110B and user 110C. More than one user, users 110B and 110C, may access the same device, device 115F. Thus, according to one embodiment of the present technology, two separate series of user interactions for user 110B and user 110C with device 115 may be tracked.

With reference to FIG. 2, a block diagram of an example UIM 105 coupled with users 110A, 110B, and 110C in accordance with an embodiment of the present technology is shown. UIM 105 includes user interaction attribute profile accessor 205, user interaction attribute profile manager 210, and user interface attribute profile generator 220. Additionally, coupled with UIM 105 is database of user interaction attribute profiles 215. UIM 105 also includes a personalized indexer 235 and a personalized data sorter 240.

Referring to FIG. 2, in one embodiment user interaction attribute profile accessor 205 accesses a user interaction attribute profile for device 115A. Devices 115A-115H are examples of the number of devices that may be coupled with users 110A-110C. It is appreciated that there may be any number devices coupled with users 110A-110C. Moreover, it should be appreciated that any number of users 110A-110C may be coupled with any one device 110A.

Additionally, for purposes of brevity and clarity, ‘user 110A’ will be used in examples herein to explain the present technology. However, it should be noted that a user other than user 110A may be used interchangeably with user 110A. Moreover, for purposes of brevity and clarity, ‘device 115A’ will be used in examples herein to explain the present technology unless otherwise noted. However, it should be noted that a device other than device 115A may be used interchangeably with device 115A. Additionally, for purposes of brevity and clarity, ‘interface 225A’ will be used in examples herein to explain the present technology unless otherwise noted. However, it should be noted that an interface other than interface 225A may be used interchangeably with interface 225A to explain the present technology, unless otherwise noted. Moreover, when reference is made to interfaces 225A-225H, this reference includes 225F(110B) and 225F(110C).

Device 115A may be any device, such as but not limited to, a mobile phone, a PDA, a desktop computer, a laptop computer, etc. The term “user interaction attribute profile” refers to a representation of one or more actions by user 110A upon device 115A. These actions may be actions contemplated to be performed upon device 115A or actions that have been performed upon device 115A. In one embodiment, some examples of data within a user interaction attribute profile is selected from the group of user interactions including, but not limited to, keys pressed, mouse movements, commands given, application usage, files accessed, searches performed, Internet browsed, email checked, user interaction attribute profile template selected, and contemplated device interaction provided.

For example, user 110A's key strokes upon a keyboard coupled with device 115A are each considered a user interaction attribute of device 115A that may be accessed at the database of user interaction attribute profiles 215. In another example, user 110A's mouse movement is considered a user interaction attribute. If user 110A moves the mouse to the far left and then to the far right of the screen, the mouse movement to the far left is a user interaction attribute, and the mouse movement to the far right is another user interaction attribute.

Commands given by user 110A to be followed by device 115A are also user interaction attributes. For instance, if user 110A commands device 115A to shut down, this ‘shut down’ command is a user interaction attribute. Similarly, user 110A's usage of various applications is also a user interaction attribute. For example, user interactions may be tracked as per, but not limited to, their time, date, and location.

User 110A's internet use and searches performed are also user interaction attributes. Every internet location user 110A accesses and every search user 110A performs are tracked according to embodiments of the present technology. Additionally, every email accessed is also a user interaction attribute that is tracked by UIM 105.

In one embodiment, a user interaction attribute profile template is selected, wherein the user interaction attribute profile template describes a contemplated device interaction with device 115A. A user interface may then be modified based on the selected user interaction attribute profile template. The term “contemplated device interaction attribute profile” refers to a desired user interaction with device 115A. In other words, ‘contemplated device interaction’ refers to a user interaction that is intended by user 110A.

In one example, user 110A selects a user interaction attribute profile template that portrays a baseball fan from a group of user interaction attribute profile templates portraying various sports fans. The baseball fan user interaction attribute profile template is preprogrammed as a series of contemplated user interaction attributes with device related to accessing particular websites associated with baseball. This baseball fan user interaction attribute profile template is substituted as user 110A's one or more user interaction attributes related to user interactions with device 115A. Thus, the baseball fan user interaction attribute profile template creates a simulated history of user 110A's interaction attributes related to user interactions with device 115A.

In another example, suppose one is buying device 115A for user 110A. The buyer may be able to customize the user interface 225A for user 110A by picking a user interaction attribute profile template out of user interaction attribute profile templates offered to the buyer. For example, buyer knows that user 110A enjoys browsing the Internet. Buyer then picks the user interaction attribute profile template, ‘Internet Enthusiast’, which includes icons representing links to favorite Internet locations. If user 110A enjoys writing, buyer may pick the user interaction attribute profile template, ‘Word Processing Guru’, which includes icons directed to spreadsheets as well as various word processing features. Additionally, the buyer may be able to customize other aspects of user interface 225A. For example, buyer may put a background picture of user 110A's dog on the user interface 225A.

In another embodiment, UIM 105 utilizes answers to questions to modify the user interface. These answers describe a contemplated interaction with a device. For example, user 110A may provide answers in response to questions regarding user 110A's one or more contemplated interactions with device 115A. The questions may be in regards to user 110A's hobbies. A question may also refer to user 110A's age. With this information, a user interface may be customized such that age appropriate websites associated with user 110A's hobbies are immediately accessible through links displayed upon device 115A's screen. These questions may be part of a wizard designed to provide a simulated history of user 110A's interaction attributes related to user interactions with device 115A after a series of questions are answered.

In one embodiment, questions may include, but are not limited to, what do you use your computer for, do you use your computer for browsing the Internet, do you use your computer for connecting with others, do you use your computer for productivity, and do you use your computer for entertainment. A user interface 225A layout may be determined based on the answers to these questions.

Additionally, a series of statements associated with contemplated user interaction attributes with regards to device 115A may be provided. User 110A may provide these statements, someone other than user 110A may provide these statements, or a default mechanism on device 115A may provide these statements. For example, user 110A may interact with a wizard by providing a series of three statements associated with a contemplated user interaction attribute profile. User 110A may state the desire to have a user interface of device 115A divided into two separate zones. The first zone desired should have only icons relating to user 110A's files containing digital photos. The second zone desired should have only icons relating to websites associated with photography which user 110A has previously accessed. In effect, user 110A is able to direct UIM 105 to consider user 110A's stated preferences as simulated user interactions to be accessed.

UIM 105 accesses each user 110A interaction attribute of database of user interaction attribute profiles 215 related to device 115A. The following are examples of user interaction attributes associated with a subject matter of photos. For example, user 110A uses one tool to open file A having photo X within it in order to view the photo. Then user 110A uses another tool to edit photo X within file A. Next, user 110A uses yet another tool to access an Internet location for sharing and printing the photo X within file A. Thus, UIM 105 then may automatically recognize that file A is associated with a series of related user interaction attributes having to do with viewing, editing, sharing, and printing photo X.

Next, UIM 105 provides links to these various tools relating to editing and printing photo X. For example, when user 110A opens file A with photo X, interface 225A displays links to tools for editing, sharing, and printing photo X.

In another example, file A may be stored in different places. For example, user 110A may store file A in a ‘my photo directory’. Many other files are also stored in ‘my photo directory’. UIM 105 recognizes that these files stored in ‘my photo directory’ may be related and provides links accordingly. Effectively, through accessing user 110A's user interaction attribute profile related to device 115A, UIM 105 learns at least but not limited to, where items are located, a user's sequential use of computer components, and what programs are used to open different files.

In one embodiment, user interaction attribute profile manager 210 is configured for sending a user interaction attribute profile to database of user interaction attribute profiles 215 for storage. In another embodiment, user interaction attribute profile manager 210 may generate a user interaction attribute for user 110A for device 115A. Additionally, user interaction attribute profile manager 210 may generate user interaction attribute for users 110A-110C for devices 115A-115C. For example, user 110A may have interactions with devices 115A, 1158, and 115C. Additionally, user 110A may have interactions with devices 115A, 115B, 115C, and 115D. In another example, users 110A-110C may have interactions with devices 115A-115H.

In one embodiment user interaction attribute profile manager 210 sends a user interaction attribute to a database of user interaction attribute profiles 215 for storage. For example, user interaction attribute profile manager 210 sends each accessed user interaction attribute to database of user interaction attribute profiles 215 that holds the user interaction attribute profiles associated with each device of devices 115A-115H and each user of users 110A-110H.

In other words, not only are all of the user interaction attribute profiles for each device of devices 115A-115H stored, but these user interaction attribute profiles are stored in association with each of a particular user of users 110A-110C. These user interaction attribute profiles are stored in database of user interaction attribute profiles 215 according to which device of devices 115A-115H they are related. Thus, database of user interaction attribute profiles 215 provides an accessible history of user-specific interactions associated with each device of devices 115A-115H.

As indicated herein, in one embodiment, UIM 105 is coupled with database of user interaction attribute profiles 215. Database of user interaction attribute profiles 215 may be external to UIM 105. For example, database of user interaction attribute profiles 215 may be located at or accessible through an online provider. However, in another embodiment, UIM 105 includes database of user interaction attribute profiles 215. In other words, in one embodiment, database of user interaction attribute profiles 215 is internal to UIM 105.

In one embodiment, user interaction attribute profile manager 210 enables sharing a specific user's user interaction attribute profile related to device 115A with device 115B. In other words, the user interaction attribute profile may be transferred from first device 115A to second device 115B. For example, first device 115A may be a desktop computer. First device 115A has user interface 225A which is customized for user 110A. User 110A buys a personal data assistant (PDA) 115B of which the user interface 225B user 110A contemplates to be customized based on user 110A's user interaction attribute profile with device 115A. User interaction attribute profile manager 210 then enables user 110A to effectively transfer the user interaction attribute profile pertaining to user 110A on device 115A, as stored in database of user interaction attribute profiles 215, to device 115B. User interface 225B of device 115B may then be modified such that it corresponds to user 110A's user interaction attribute profile related to device 115A, as stored in database on user interaction attribute profiles 215.

It should be appreciated that devices 115A-115H may be products of the same company and therefore programmed to receive migrating user interfaces 225A-225H and modify user interfaces 225A-225H accordingly. However, it may also be that devices 115A-115H are products of different companies, and UIM 105 is programmed to be compatible with devices 115A-115H of different companies such that UIM 105 enables the modification of user interfaces 225A-225H of devices 115A-115H based on a user interaction attribute profile.

In one embodiment, sharing the user interaction attribute profile involves storing the user interaction attribute profile of device 115A on a portable memory device, such as a universal serial bus (USB) stick memory. The user interaction attribute profile on the USB stick memory may then be connected to device 115B and downloaded onto device 115B. Thus, a USB stick memory provides a way of storing the user interaction attribute profile external to device 115A and/or UIM 105.

In another embodiment, and as described herein, the user interaction attribute profile may be stored at a company and accessible through an online service. For example, user 110A buys a new device 115B using an online service. While in the process of buying device 115B, user 110A states his name, and then states that he wants his user interaction attribute profile associated with device 115A to be applied to new device 115B. Device 115A's user interaction attribute profile that is stored at the company is then applied to device 115B. Device 115B is then shipped to customer user 110A with a customized user interface 225B.

In one embodiment, a plurality of user interaction attribute profiles for device 115A is accessed. A modification of a plurality of user interfaces 225A, 225B, 225C associated with device 115A is then provided. The modification is specific to each of the plurality of user interaction attribute profiles. For example, each of a plurality of user interaction attribute profiles for a single device 115F is stored at database of user interaction attribute profiles 215. In one example, one, some, or all of the plurality of user interaction attribute profiles are selected user interaction attribute profile templates.

In another example, one, some, or all of the plurality of user interaction attribute profiles is based on generated user interaction attributes. For example, there is a separate user interaction attribute profile associated with each user 110A-110C. Each user 110A-110C may be associated with any number of devices 115A-115H for which a user interaction attribute profile is stored. User interfaces 225A-225H of devices 115A-115H may be modified based on the stored user interaction attribute profiles. In other words, each device of devices 115A-115H will have a different resulting user interface for each user of users 110A-110C.

Referring still to FIG. 2, in one embodiment user interface generator 220 generates a user interface 225A of device 115A based on a user interaction attribute profile. For example, a desktop home screen or the starting view for user 110A is modified. Moreover, icons and application data shortcuts may be modified. It should be appreciated that any aspect associated with user interface 225A may be modified based on a user interaction attribute profile.

In one embodiment, user interface generator 220 comprises a personalized data sorter 235 that sorts data into related sets based on a user interaction attribute profile. For example, suppose that when user 110A is reading a particular email described as “test”, user 110A also accesses a particular word processing document, “test taking strategies”. Furthermore, the user interaction attribute profile indicates that when user 110A is looking at a certain email described as “test”, 5 times out of 9 times user 110A accesses the “test taking strategies” word processing document. Consequently, in one example, while user 110A is viewing the email ‘test’ on his mobile phone device 115C, device 115C may indicate to user 110A that ‘test taking strategies’ is located on user 110A's desktop. Device 115C also may ask if user 110A wants device 115C to access and download a copy of “test taking strategies” from desktop 115A to user 110A's mobile phone 115C.

It should be appreciated that personalized data sorter 235 may be coupled internally with or external to user interface generator 220.

In another example, device 115C may display a message to user 110A to remind user 110A that the file “test taking strategies” of desktop computer 115A is a file that user 110A may want to access. The personalized data may be shared across devices 115A-115C while taking into account data gathered on devices 115A-115C.

In one embodiment, UIM 105 includes a personalized indexer 240 to index data based on a user interaction attribute profile. The term “index” here is used to refer to organizing data. In one embodiment, this information is related to devices 115A-115C that are coordinated with each other. Devices 115A-115C are coordinated with each other such that user 110A's interaction with device 115A affects user 110A's breadth and depth of interaction with device 115B and 115C.

Consequently, due to this coordination, when user 110A wishes to search for information relating to a particular subject matter, a search may be performed across all three different devices 115A, 115B, 115C to access all related data. Additionally, devices 115A, 115B, and 115C are updated to correspond with each other in response to new user interaction attribute profiles associated with user 110A with any one device 115A-115C.

In one embodiment, information associated with user 110A may be tagged. The term “tag” refers to assigning a reference name to certain information. For example, a certain file, a photo, and a webpage of user 110A may be contemplated to be associated with the words ‘high school’. Thus, the file, the photo, and the webpage are all tagged. When the words high school are typed into device 115A as a search, the tagged file, photo, and webpage open for user 110A on device 115A. This information may be tagged by user 110A, someone other than user 110A, or as part of generating a user interaction attribute profile.

In another example, user 110A may click on the icon representing ‘Chelsea’, and all of the information that was tagged to relate to the word Chelsea will be represented, on device 115A's interface 225A.

In one embodiment, the method of modifying interfaces 225A is performed dynamically. For example, interface 225A is dynamically adapted based upon a plurality of user interaction attribute profiles stored in database of user interaction attribute profiles 215. In one embodiment, interface 225A is dynamically and gradually adapted since the user interaction attribute profile is gradually learned while user 110A interacts with device 115A.

For example, in one embodiment, in the most recent four consecutive interactions, when user 110A accesses file A and file B on device 115A, user 110A also accesses file C on device 115A. This pattern of user interactions with device 115A is stored in database of user interaction attribute profiles 215 as part of a user specific user interaction attribute profile. Based on user 110A's most recent user interaction attribute profile with device 115A, UIM 105 modifies user interface 225A to include a link to file C when user 110A once again accesses file A and file B.

In one embodiment, gradual transitions/adaptations of user interface 225A are time referenced and/or frequency referenced. For example, user interface 225A is modified based upon user 110A's user interaction attribute profile related to device 115A during a certain period of elapsed time. For instance, user 110A frequently accesses file A containing photo A. However, user 110A's most recent user interaction attributes relating to device 115A shows that when user 110A accesses file A with photo A on device 115A, user 110A also accesses file B containing video A on device 115A. UIM 105 then recognizes this pattern of user interaction attributes related to device 115A and modifies user interface 225A accordingly. Thus, the next time that user 110A opens file A, file B also appears on user interface 225A.

It should be appreciated that more than just interface 225A may be modified based upon user 110A's most recent user interaction attributes related to device 115A. User interfaces 225B and 225C of devices 115B and 115C respectively, that are also associated with user 110A, may be modified to coordinate with the user interaction attribute profile of user 110A with device 115A.

It should also be appreciated that there are any number of ways to indicate gradual dynamic changes in user interfaces 225A based upon user 110A's user interaction attribute profile with device 115A. For example, based upon an observed frequency of use of file A, an icon representing file A may appear to fade out (weaken) and fade in (strengthen) on user interface 225A.

In another example, icons may be rearranged on user interface 225A to accommodate user 110A's contemplated user interaction attributes related to files of device 115A. For example, if user 110A uses file A and file B more often than file C and file D, then icons representing files A and B may gradually migrate to the center of user interface 225A. Files C and D may gradually migrate to the perimeter of user interface 225A.

In one embodiment, the user interaction attribute profile and user interface 225 may be manually configured. In another embodiment, an automatically configured user interface 225 is displayed unless user 110A manually overrides the default in order to manually configure user interface 225A.

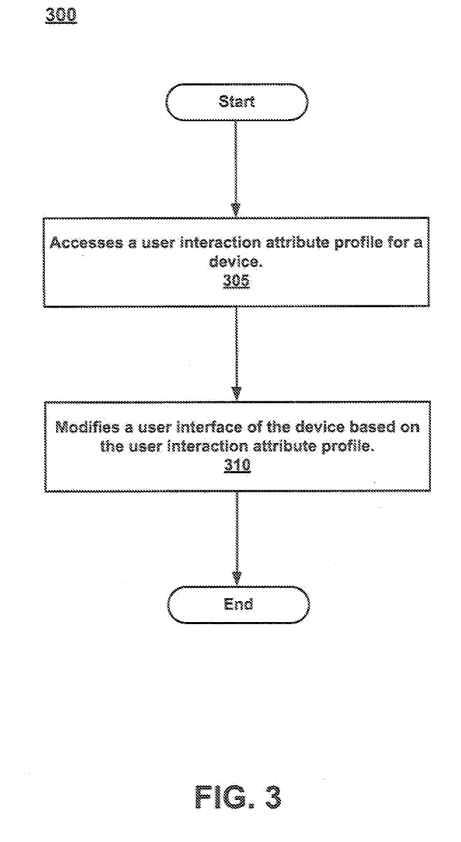

FIG. 3 is a flowchart of an example method of modifying a user interface 225A of device 115A in accordance with embodiments of the present technology.

Referring now to 305 of FIG. 3 and as described herein, one embodiment accesses a user interaction attribute profile for device 115A.

In one embodiment and as described herein, answers to questions are utilized to modify user interface 225A, wherein the answer describes a contemplated user interaction attribute related to device 115A. In another embodiment, a user interaction attribute profile template is selected. User interface 225A is then modified based on the selected user interaction attribute profile template.

In one embodiment and as described herein, a plurality of user interaction attribute profiles related to device 115F is accessed. A modification of a plurality of user interfaces 225(110B) and 225(110C) associated with device 115F is provided. The modification is specific to each of the plurality of user interaction attribute profiles.

For example, not only does UIM 105 generate a user interaction attribute profile for each user 110A-110C for devices 115A-115H, but also more than one user may be using the same device. Thus, UIM 105 may also generate a separate user interaction attribute profile for each user of the same device.

For example and in accordance with embodiments of the present technology, UIM 105 may account for each user of users 110B-110C of the same device 115B. UIM 105 may generate a user interaction attribute profile for device 115F as it relates to each user of users 110B and 110C. Both users 110B and 110C will have unique login information such that device 115A may recognize each user of users 110B and 110C. User interfaces 225F(110B) and 225F(110C) are modified by UIM 105 according to the stored individual user interaction attribute profiles pertaining to each user of users 110B and 110C's use of device 115F.

In yet another embodiment and as described herein, a user interaction attribute profile associated with a device is shared with a second device. For example, a user interaction attribute profile associated with device 110A is shared with device 110B.

In one example of the present technology and as described herein, data is sorted into related sets based on a user interaction attribute profile. In another example and as described herein, data is indexed based on a user interaction attribute profile. Additionally, embodiments provide for searching of user 110A's personalized data. For example, since user 110A's data may be shared across devices 115A-115C, a search of one item may be made across all three devices 115A-115C. Thus, all three devices 115A-115C may contribute to a search result, such as but not limited to, files and links to information.

In another embodiment and as described herein, user interface 225A of device 115A is modified based on the user interaction attribute profile.

In one example, the present technology described herein provides an UIM 105 for modifying user interface 225A of device 115A. UIM 105 tracks and stores a user's interaction with device 115A as a user interaction attribute profile. Then UIM 105 uses this stored user interaction attribute profile of device 115A to create a unique visual layout on user interface 225A that reflects the user 110A's contemplated interaction with device 115A. Additionally, UIM 105 may share the user interaction attribute profile of a first device 115A with a second device 115B. This sharing enables UIM 105 to create a visual layout on user interface 225B that is based on user 110A's interaction with device 115A. Consequently, interface 225B will reflect user 110A's contemplated interaction with device 115B, without having any prior interactions with device 115B.

Thus, embodiments of the present technology provide a method of modifying user interface 225A of device 115A. The present technology enables consumers to purchase and customize computing devices for others. For example, a daughter wishes to purchase a new laptop A from company A for her mother Brenda, a school teacher. It is known that Brenda uses her computer most frequently for the following activities: browsing the web for classroom ideas, checking email, designing web pages, creating, editing, and sharing movies, and editing and sharing photos.

Brenda's daughter interacts with a wizard available through company A, in which she answers questions regarding Brenda's user preferences according to Brenda's contemplated computer interactions, such as designing web pages. Brenda then receives laptop A (115A) with a user interface (225A) designed to accommodate Brenda's contemplated interactions as expressed by her daughter with laptop A (115A).

For example, only the following five representative icons appear on laptop A's (115A) user interface (225A): web page editing application shortcut, movie creation tool shortcut, and photo sharing link. Brenda then begins using laptop A (115A) and thus begins creating a user interaction history. UIM 105 then automatically modifies Brenda's laptop A (115A) according to Brenda's user interaction history.

For example, according to Brenda's user interaction history, Brenda typically only edits one web page project at a time. This interaction is tracked through UIM 105. UIM 105 then modifies Brenda's user interface (225A) of laptop A (115A) to display an icon that portrays an image of Brenda's web page project instead of a generic web page editing application icon.

Next, Brenda then purchases a mobile phone (115B). Brenda wishes the user interface (225B) of her mobile phone (115B) to coordinate with her user interactions with laptop A (115A). UIM 105 then enables the sharing of the user interactions stored in the database of user interactions 215 that pertain to the user interface (225A) of Brenda's laptop A (115A). UIM 105 may share these stored user interactions with Brenda's new mobile phone (115B) in order to modify the user interface (225B) of the mobile phone (115B). In this manner, Brenda does not have to initialize another computing device, such as her mobile phone (115B), to reflect her user interaction preferences. Now, Brenda's ever changing user interaction preferences can be dynamically tracked and reflected in an assortment of compatible and coordinating devices 115A-115C.

### Example Computer System Environment

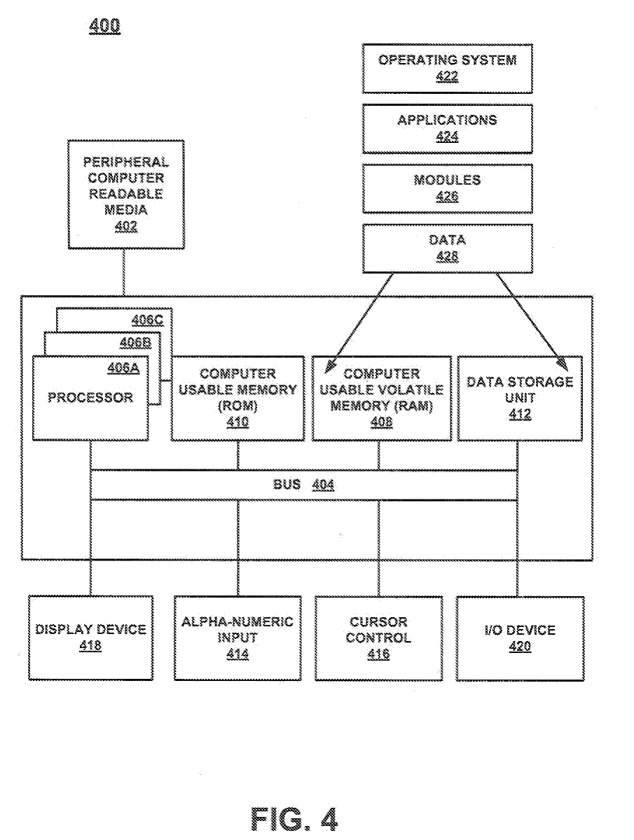

With reference now to FIG. 4, portions of the technology for providing a communication pathway within a set of conjoined blades are composed of computer-readable and computer-executable instructions that reside, for example, in computer-usable media of a computer system. That is, FIG. 4 illustrates one example of a type of computer that can be used to implement embodiments, which are discussed below, of the present technology.

FIG. 4 illustrates an example computer system 400 used in accordance with embodiments of the present technology. It is appreciated that system 400 of FIG. 4 is an example only and that the present technology can operate on or within a number of different computer systems including general purpose networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet. A more detailed discussion of the present technology is found below.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. The present technology may be applied to one or more elements of described system 400. For example, a method of modifying user interface 225A of device 115A may be applied to operating system 422, applications 424, modules 426, and/or data 428.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

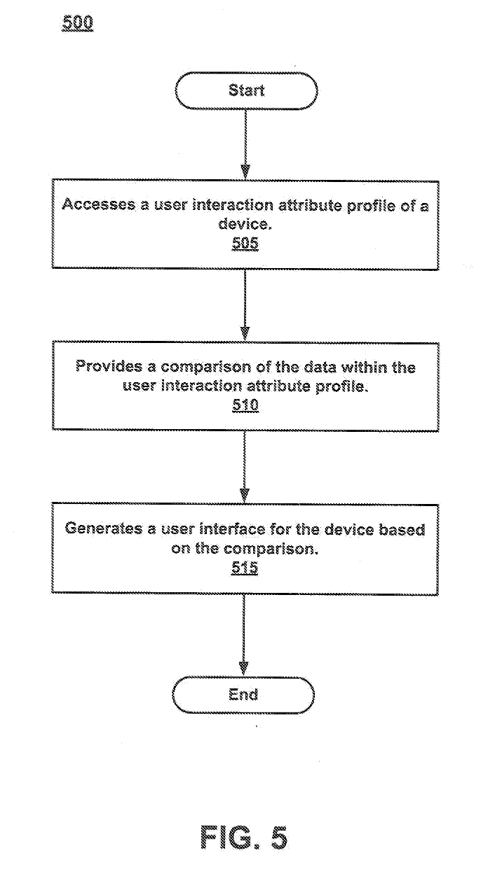

FIG. 5 is a flowchart of an example method of modifying user interface 225A of device 115A in accordance with embodiments of the present technology.

Referring now to 505 of FIG. 5 and as described herein, one embodiment accesses a user interaction attribute profile of device 115A.

Referring now to 510 of FIG. 5 and as described herein, one embodiment provides a comparison of data within a user interaction attribute profile. For example, a first user interaction attribute associated with device 115A is compared with a second, third, fourth, etc. user interaction attribute with the same device 115A. If all of the first, second, third, and fourth, etc. user interaction attributes are the same, UIM 105 does not perform any modification of user interface 225A of device 115A unless specifically directed to do so. However, if any of the first, second, third, and fourth, etc. user interactions are different from each other, then UIM 105 modifies user interface 225A of device 115A accordingly and as described herein. Modification in this instance may be dependent upon predetermined time and frequency parameters of user interaction attributes.

Referring now to 515 of FIG. 5 and as described herein, one embodiment generates a user interface 225A for device 115A based on the comparison.

In one embodiment and as described herein, the comparison of data within a user interaction attribute profile is provided to a second device. For example, the comparison of data within a user interaction attribute profile associated with device 115A is provided to device 115B. A user interface for a second device based on this comparison is generated. For example, user interface 225B for device 115B based on a comparison of data with a user interaction attribute profile associated with device 115A is generated.

In one embodiment and as described herein, a plurality of comparisons are accessed at a database of user interaction attribute profiles 215. For example a plurality of comparisons of data within user interaction attribute profiles associated with devices 115B and 115C are accessed. A plurality of user interfaces specific to each of the plurality of comparisons are generated. For example, a plurality of user interfaces 115F(110B) and 115F(110C) specific to each of the plurality of comparisons associated with device 115F are generated.

Thus, the present technology provides a method and system of modifying a user interface 225A of device 115A. This is done by utilizing user 110A's user interaction attribute profile to determine the necessary modifications of user interface 225A. These modifications are based upon changes in user 110A's user interaction attribute profile with device(s) 115A-115C, such that user interface 225A will reflect user 110A's current usage interactions in a unique visual layout. Moreover, the continuously updated usage preferences that are reflected in user interface 225A may be shared with devices 115B and 115C in order to modify and update user interfaces 225B and 225C. Consequently, when purchasing new computing devices, user 110A avoids having to initialize each device 115A-115C to accommodate user 110A's usage preferences, consequently saving time and resources.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method [300] of modifying a user interface, said method comprising:
accessing a user interaction attribute profile for a device [305]; and
modifying a user interface of said device based on said user interaction attribute profile [310].

2. The method [300] of claim 1, wherein said accessing a user interaction attribute profile for a device comprises:
utilizing answers to questions to modify said user interface, said answers describing a contemplated user interaction attribute related to said device.

3. The method [300] of claim 1, wherein said modifying a user interface comprises:
accessing a selected user interaction attribute profile template; and
modifying said user interface based on said selected user interaction attribute profile template.

4. The method [300] of claim 1, further comprising:
accessing a plurality of user interaction attribute profiles for said device; and
providing a modification of a plurality of user interfaces associated with said device, said modification specific to each of said plurality of user interaction attribute profiles.

5. The method [300] of claim 1, further comprising:
sharing said user interaction attribute profile associated with said device with a second device.

6. The method [300] of claim 1, wherein said modifying a user interface comprises:
sorting data into related sets based on said user interaction attribute profile.

7. The method [300] of claim 1, wherein said modifying a user interface comprises:
indexing data based on said user interaction attribute profile.

8. A user interface modifier (UIM) [105] comprising:
a user interaction attribute profile accessor [205] configured for accessing a user interaction attribute profile associated with a device;
a user interaction attribute profile manager [210] configured for sending said user interaction attribute profile to a database of user interaction attribute profiles [215] for storage; and
a user interface generator [220] configured for generating a user interface of said device based on said user interaction attribute profile.

9. The UIM [105] of claim 8, wherein data within said user interaction attribute profile is selected from the group of user interactions consisting of: keys pressed, mouse movements, commands given, application usage, files accessed, searches performed, email checked, internet browsed, user interaction template selected, and contemplated device interaction provided.

10. The UIM [105] of claim 8, further comprising:
a database of user interaction attribute profiles [215] within which said user interaction attribute profile is stored.

11. The UIM [105] of claim 8, wherein said database [215] is internal to said UIM [105].

12. The UIM [105] of claim 8, wherein said database [215] is external to said UIM [105].

13. A computer usable medium wherein instructions thereon, when executed cause a computer system to perform a method [500] of modifying a user interface of a device to enhance a user's interaction with said device, said method comprising:
accessing a user interaction attribute profile of a device [505];
providing a comparison of said data within said user interaction attribute profile [510]; and
generating a user interface for said device based on said comparison [515].

14. The computer usable medium of claim 13, wherein the method [500] further comprises:
providing said comparison to a second device; and
generating a user interface for said second device based on said comparison.

15. The computer usable medium of claim 13, wherein the method [500] further comprises:
accessing a plurality of comparisons at a database of user interaction attribute profiles; and
generating a plurality of user interfaces specific to each of said plurality of comparisons.
